(19) United States
(12) Patent Application Publication
(10) Pub. No.: US 2020/0294057 A1
(43) Pub. Date: Sep. 17, 2020

(54) BUSINESS PROCESSING METHOD, APPARATUS, AND EQUIPMENT

(71) Applicant: ALIBABA GROUP HOLDING LIMITED, GRAND CAYMAN (KY)

(72) Inventor: Hao DONG, HANGZHOU (CN)

(21) Appl. No.: 16/888,797

(22) Filed: May 31, 2020

Related U.S. Application Data
(63) Continuation of application No. PCT/CN2020/071754, filed on Jan. 13, 2020.

(30) Foreign Application Priority Data
Jul. 17, 2019 (CN) 201910646764.0

(51) Int. Cl. G06Q 20/40; G06Q 20/38; G06Q 40/02

(52) U.S. Cl. CPC G06Q 20/4016; G06Q 40/025; G06Q 20/381

(57) ABSTRACT

A method, device, medium, and equipment for service processing, comprising: by a server, determining, a first characteristic value of preset service characteristics of a target service to be processed, wherein the first characteristic value is determined based on attribute information of at least one input parameter objective of an interface that is called to process the target service; processing, the target service to obtain a processing result; determining, a second characteristic value of the preset service characteristics corresponding to the processing result of the target service, wherein the second characteristic value is determined based on attribute information of at least one output parameter objective of an interface that is called to process the target service; and in response to determining that the first characteristic value and the second characteristic value do not match, prohibiting, output of the processing result.

### CROSS-REFERENCE TO RELATED APPLICATION

This application is a continuation application of International Patent Application No. PCT/CN2020/071754, filed with the China National Intellectual Property Administration (CNIPA) on Jan. 13, 2020, which is based on and claims priority to and benefit of Chinese Patent Application No. 201910646764.0, filed with the CNIPA on Jul. 17, 2019. The entire contents of all of the above-identified applications are incorporated herein by reference.

### TECHNICAL FIELD

The specification relates to the field of computer technology, especially to a method, a device, a storage medium, and equipment for service processing.

### BACKGROUND ART

Tampering of currency may refer to a situation that a processing node may tamper the original currency during processing of a capital service, resulting in inconsistent currency information before and after the processing of the capital service.

With the international expansion, e-commercial banks may be also required to support the service demands of other currencies, in addition to the domestic currency. Therefore, when establishing a capital processing system for multiple currencies, it is necessary to consider risks of currency tampering.

Therefore, more reliable service processing solutions need to be provided.

### SUMMARY

Embodiments of the specification provide a method for service processing, which can effectively prevent and control the risks of currency tampering. The method may include: determining first currency information of a capital service to be processed; determining second currency information corresponding to a processing result of the capital service; and prohibiting output of the processing result if the first currency information and the second currency information do not match.

Embodiments of the specification also provide a method for service processing, comprising: determining a first characteristic value for preset service characteristics of a target service to be processed; determining a second characteristic value for the preset service characteristics corresponding to a processing result of the target service; and prohibiting output of the processing result if the first characteristic value and the second characteristic value do not match.

Embodiments of the specification also provide a device for service processing, comprising: a first determining module, used for determining first currency information of a capital service to be processed; a second determining module, used for determining second currency information corresponding to a processing result of the capital service; and a processing module, used for prohibiting output of the processing result if the first currency information and the second currency information do not match.

Embodiments of the specification also provide a device for service processing, comprising: a first determining module, used for determining a first characteristic value for preset service characteristics of a target service to be processed; a second determining module, used for determining a second characteristic value for the preset service characteristics corresponding to a processing result of the target service; and a processing module, used for prohibiting output of the processing result if the first characteristic value and the second characteristic value do not match.

Embodiments of the specification also provide electronic equipment, comprising: a processor; and a memory, arranged to store computer executable instructions, which, when executed, enable the processor to execute the steps contained in the above method.

Embodiments of the specification also provide a computer readable storage media, wherein the computer readable storage media stores a computer program, and the computer program, when executed by the processor, realizes the steps contained in the above method.

According to a further aspect, embodiments of the specification provide a method for service processing, comprising: by a server, determining, a first characteristic value of preset service characteristics of a target service to be processed, wherein the first characteristic value is determined based on attribute information of at least one input parameter objective of an interface that is called to process the target service; processing, the target service to obtain a processing result; determining, a second characteristic value of the preset service characteristics corresponding to the processing result of the target service, wherein the second characteristic value is determined based on attribute information of at least one output parameter objective of an interface that is called to process the target service; and in response to determining that the first characteristic value and the second characteristic value do not match, prohibiting, output of the processing result.

In an embodiment, the at least one input parameter objective of an interface that is called to process the target service is determined by determining at least one interface that is called to process the target service, and reading input parameters of the interface when detecting that one of the at least one interface is called, to obtain the input parameter objective of the interface.

In an embodiment, the at least one input parameter objective comprises at least one of a first input parameter objective of a remote service interface and a second input parameter objective of a local service interface, the second input parameter objective comprises at least one of an input parameter objective of data and an input parameter objective of messages, objective of the data includes service data related to the target service, and objective of the messages include an interaction message between local applications.

In an embodiment, the at least one input parameter objective of an interface that is called to process the target service is determined by determining at least one interface that is called to process the target service, and reading output parameters of the interface when detecting that one of the at least one interface is called, to obtain the output parameter objective of the interface.

In an embodiment, the at least one output parameter objective comprises at least one of a first output parameter objective of a remote service interface and a second output parameter objective of a local service interface, the second output parameter objective comprises at least one of an output parameter objective of data and an output parameter objective of messages, objective of the data includes the processing result of the target service, and objective of the messages include an interaction result between local applications.

In an embodiment, the method further comprises: determining whether the first characteristic value and the second characteristic value are the same; and in response to determining that the first characteristic value and the second characteristic value are the same, determining that the first characteristic value and the second characteristic value match, and in response to determining that the first characteristic value and the second characteristic value are not the same, determining that the first characteristic value and the second characteristic value do not match; wherein, the first characteristic value is determined based on a target input parameter of a first interface called to process the target service objective, and the second characteristic value is determined based on a target output parameter of a second interface called to process the target service.

In an embodiment, the method further comprises: allowing the output of the processing result if the first characteristic value and the second characteristic value match; and generating alarm information if the first characteristic value and the second characteristic value do not match.

In another aspect, electronic equipment for service processing is provided. The equipment comprises a processor and a non-transitory computer-readable storage medium storing instructions executable by the processor to cause the system to perform operations comprising: determining, a first characteristic value of preset service characteristics of a target service to be processed, wherein the first characteristic value is determined based on attribute information of at least one input parameter objective of an interface that is called to process the target service; processing, the target service to obtain a processing result; determining, a second characteristic value of the preset service characteristics corresponding to the processing result of the target service, wherein the second characteristic value is determined based on attribute information of at least one output parameter objective of an interface that is called to process the target service; and in response to determining that the first characteristic value and the second characteristic value do not match, prohibiting, output of the processing result.

In another aspect, a non-transitory computer-readable storage medium for service processing is provided. The medium configured with instructions executable by one or more processors to cause the one or more processors to perform operations comprising: determining, a first characteristic value of preset service characteristics of a target service to be processed, wherein the first characteristic value is determined based on attribute information of at least one input parameter objective of an interface that is called to process the target service; processing, the target service to obtain a processing result; determining, a second characteristic value of the preset service characteristics corresponding to the processing result of the target service, wherein the second characteristic value is determined based on attribute information of at least one output parameter objective of an interface that is called to process the target service; and in response to determining that the first characteristic value and the second characteristic value do not match, prohibiting, output of the processing result.

At least one of the above technical solutions used in the embodiments of the specification can achieve the following beneficial effects.

The currency information is determined before the capital service processing, and the currency information is determined again after the capital service processing. If the currency information before the capital service processing and the currency information after the capital service processing are inconsistent, output of the processing result of the capital service is intercepted. Compared with the prior art, it can effectively monitor whether the currency is tampered or not, thus avoiding a capital loss caused by tampering of currency.

### BRIEF DESCRIPTION OF DRAWINGS

The appended drawings provide a further understanding of the specification and form a part of the specification, and the embodiments of the specification and their descriptions are used to interpret the specification and do not constitute any limitation of the specification.

FIG. 1 is a flow chart of a method for service processing provided in one embodiment of the specification.

FIG. 2 is a flow chart of a method for service processing provided in another embodiment of the specification.

FIG. 3 is a structure diagram of a device for service processing provided in one embodiment of the specification.

FIG. 4 is a structure diagram of a device for service processing provided in another embodiment of the specification.

FIG. 5 is a structure diagram of a system for service processing provided in one embodiment of the specification.

FIG. 6 is a structure diagram of electronic equipment provided in one embodiment of the specification.

### DETAIL DESCRIPTION OF THE EMBODIMENTS

In order to make the purpose, technical solutions and advantages of the specification clearer, a clear and thorough description of the specification will be provided in combination with the specific embodiments of the specification and the corresponding drawings. The embodiments described are only a portion but not all of the embodiments of the specification. All other embodiments obtained by those skilled in the art based on the embodiments given herein without making any creative effort should fall within the scope of the protection scope of the specification.

As described in the background section, the tampering of currency in the system may lead to confusion of the data such as the capital data and cause capital loss. The specification provides a service processing solution for solving this problem. By comparing the consistency of currency information before and after the capital service processing, a decision can be made whether to intercept the output of the processing result of the capital service, to effectively monitor and control the tampering of currency.

The capital service refers to the capital related services, such as loan service, transaction service, and the like. The currency refers to the names or types of the currencies of different countries, such as CNY, USD, GBP, and the like.

The technical solutions provided by the embodiments of the specification are described in detail below in conjunction with the drawings.

FIG. 1 is a flowchart of a method for service processing provided in one embodiment of the specification. Referring to FIG. 1, according to some embodiments, the method can include the following steps.

In Step 102, first currency information of a capital service to be processed is determined.

The Step 102 may further comprise Step S1, at least one input parameter objective or destination of an interface that is called to process the capital service is determined.

First, at least one interface that is called to process the capital service is determined. When detecting that any of the at least one interface is called, the input parameters of the interface are read to obtain the input parameter objective of the interface, wherein the input parameters of the interface may provide information for determining the objective, destination, or location of the interface.

The tool that reads the input parameters of the interface can include a Spring interceptor. The following is a brief explanation of how the Spring interceptor works.

First, the Spring interceptor and the specified interface are bound together. Based on the binding relationship, after the interface is called and before actions of the interface are executed, the contents of the interface may enter a first interceptor (i.e., a first Spring interceptor,) and the first interceptor may read the input parameters of the interface. After the input parameters of the interface are read, the contents of the interface are executed. After the execution of the contents of the interface, the interface returns an output parameter to the calling party that calls the interface. Based on the binding relationship, before being returned to the calling party, the output parameter enters a second interceptor (i.e., a second Spring interceptor,) and the second Spring interceptor reads and returns the output parameter to the calling party.

In Step S2, the first currency information of the capital service is determined based on the attribute information of the at least one input parameter objective. Step S2 may include the following steps.

In Step S21, the attributes of the at least one input parameter objective is traversed to find the preset currency attributes.

The attributes of the input parameter objective refer to the characteristics and status that the input parameter objective has. Using middle school students as an example, the attributes at least include the student number, class, grade, and the like. The names of the preset currency attributes for different types of input parameter objectives can be different. For example, if MultiCurrencyMoney is preset as a type of amount in the system, then a currency attribute of MultiCurrencyMoney will be searched for.

In Step S22, the first currency information of the capital service is determined based on the attribute information of the currency attribute.

The value of the currency attribute can be used to represent currency information. For example, when the attribute value is 1, the currency is CNY, when the attribute value is 2, the currency is USD, and so on.

For step S1 and step S2, since a capital service processing system typically has three types of data input, such as remote call parameters, storage-level data, and communication messages, and each kind of data comprises currency information, the steps S1 and S2 can be illustrated as follows.

First, all remote and local service interfaces that are called to process the capital service are determined. Then, the input parameter objective for each remote service interface (i.e., remote calling parameter of system) and the input parameter objective for each local service interface are determined, which are respectively denoted as the first input parameter objective and the second input parameter objective.

The remote service interface may refer to the service interface of remote computers, while the local service interface generally refers to the service interface of a capital service processing system. The second input parameter comprises at least one of an input parameter objective of data (i.e., the storage-level data read by the system) and an input parameter objective of messages (i.e., communication messages received by the system application from other applications). The input parameter objective of data is the service data related to the capital service, and the input parameter objective of messages is interactive messages among the local applications that participate in the processing of the capital service.

After that, the Spring interceptor is used for intercepting and reading the three input parameter objectives, and the currency attribute is analyzed to determine the corresponding first currency information.

Further, to ensure the accuracy of the determined first currency information, the embodiment also includes a first currency verification.

First, a currency information list is generated for storing the currency information corresponding to each input parameter objective, that is, the currency information is determined based on the attribute of each input parameter objective. Then the currency information in the currency information list is compared for consistency. If the currency information is consistent, any of the currency information can be set as the first currency information. If the currency information is inconsistent, a common currency information may be selected as the first currency information.

The common currency information may refer to the currency information that occurs the most in the currency information list.

In Step 104, the second currency information corresponding to the processing result of the capital service is determined. Step 104 may include following steps.

In Step S1′, at least one output parameter objective of an interface that is called to process the capital service is determined.

First, at least one interface that is called to process the capital service is determined, and then the output parameter of any of the at least one interface is intercepted to obtain the output parameter objective of the interface.

The tool that reads the output parameter of the interface can be a Spring interceptor. Since the working principle of the interceptor has been described in detail above, it will not be repeated herein.

In Step S2′, the second currency information for the processing result of the capital service is determined based on the attribute information of the at least one output parameter objective.

The attributes of at least one output parameter objective is traversed to find the preset currency attributes, and the second currency information of the capital service is determined based on the attribute information of the currency attribute.

The names of preset currency attributes for different types of input parameter objectives can be different.

For the step S1′ and step S2′, since a capital service processing system typically has three types of data output, such as remote return parameters, storage-level data, and communication messages, and each kind of data comprises currency information, the steps S1′ and S2′ can be illustrated as follows.

First, all remote and local service interfaces that are called to process the capital service are determined. Then, based on the binding relationship between the Spring interceptor and each interface, the output parameter objective for each remote service interface (i.e., remote return parameter of system) and the output parameter objective for each local service interface are determined, which are respectively denoted as the first output parameter objective and the second output parameter objective.

The second output parameter objective comprises at least one of an output parameter objective of data (i.e., the storage-level data stored by the system) and an output parameter objective of messages (i.e., communication messages sent to other applications by the system application), the output parameter objective of data is the service data related to the capital service, and the output parameter objective of messages is interactive messages among the local applications that participate in the processing of the capital service.

After that, the Spring interceptor is used for intercepting and reading the three output parameter objectives, and the currency attribute is analyzed to determine the corresponding second currency information.

Further, to ensure the accuracy of the determined second currency information, the embodiment also includes a second currency verification, which may comprise the following steps.

First, a currency information list is generated for storing the currency information corresponding to each output parameter objective, that is, the currency information is determined based on the attribute of each input parameter objective, and the currency information in the currency information list are compared for consistency. If the currency information is consistent, any currency information may be set as the second currency information, and if the currency information is inconsistent, a common currency information is selected as the second currency information.

The common currency information may refer to the currency information that occurs the most in the currency information list.

In Step 106, the output of the processing result is prohibited if the first currency information and the second currency information do not match.

In an embodiment, whether the first currency information and the second currency information are the same may be determined. If they are the same, the first currency information and the second currency information are determined to be matched, and if they are not the same, the first currency information and the second currency information are determined not to be matched. Followings are some examples.

Example 1, matching the common first currency information and second currency information.

First, based on the first currency verification, the first common currency information is determined from the currency information corresponding to each of the at least one input parameter objective. Similarly, based on the second currency verification, the second common currency information is determined from the currency information corresponding to each of the at least one output parameter objective.

After that, the first common currency information and second common currency information are compared for consistency to determine whether they match or not.

Example 2, matching the currency information of each pair of input and output parameter objectives.

First, based on the steps S1 and S2, the first currency information corresponding to any target input parameter objective (such as input parameter objective of data) of the at least one input parameter objective is determined. Then based on steps S1′ and S2′, the second currency information for the target output parameter objective (such as output parameter objective of data) corresponding to the target input parameter objective is determined.

The target input parameter objective and the target output parameter objective are a pair of input parameter objective and output parameter objective for any interface that is called to process the capital service.

Then, the first currency information corresponding to the input parameter objective of data and the second currency information corresponding to the output parameter objective of data are compared for consistency.

Similarly, the first and second currency information respectively corresponding to other pairs of input parameter objectives and output parameter objectives are compared. If the first and second currency information respectively corresponding to each pair of input parameter objectives and output parameter objectives are consistent, then the matching is successful, and output of the processing result is allowed. If any pair of the first and second currency information are not consistent, then the matching is failed, and alarm information is issued to notify developers and maintenance personnel to handle this situation.

In this embodiment, the currency information is determined before the capital service processing, and the currency information is determined again after the capital service processing. If the currency information before the capital service processing and the currency information after the capital service processing are inconsistent, the output of the processing result of the capital service is intercepted or prohibited. Compared with the prior art, the method can effectively monitor whether the currency is tampered or not, thus avoiding the capital loss caused by tampering of currency.

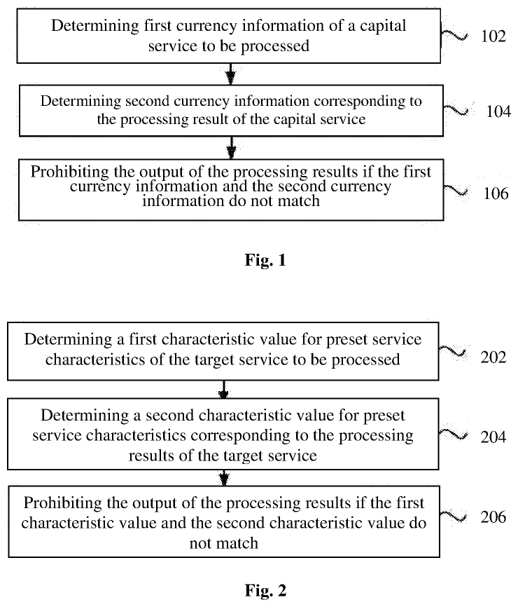

FIG. 2 is a flowchart of a method for service processing provided in another embodiment of the specification. Referring to FIG. 2, the method can include the following steps.

In Step 202, a first characteristic value for the preset service characteristics of the target service to be processed is determined.

The preset service characteristics correspond to the type of target service and generally refer to the characteristics that are preset based on the service processing requirements. For example, when the target service is a capital service, the preset service characteristics can be currency information, ID information, and the like. When the target service information is a package service, the preset service characteristics can be cell-phone numbers and the like.

Step 202 may be implemented as follows.

At least one input parameter objective that is called to process the target service is determined, and the first characteristic value for the preset service characteristics of the target service is determined based on the attribute information of the at least one input parameter objective.

Using the package service as an example, the implementation may include following steps.

First, at least one interface that is called to process the package service is determined, when detecting any of the at least one interface is called, the input parameter of the interface is read, to obtain the input parameter objective of the interface.

Then, the attributes of at least one input parameter objective is traversed to find the attributes (such as attribute of cell-phone number) corresponding to the preset service characteristics, and the first characteristic value for the preset service characteristics is determined based on the attribute information of the attribute, that is, the first cell-phone number.

The at least one input parameter objective comprises at least one of a first input parameter objective of a remote service interface and a second input parameter objective of a local service interface, the second input parameter objective comprises at least one of an input parameter objective of data and an input parameter objective of messages, the objective or a destination of data includes the service data related to the package service, and the objective or a destination of messages includes the messages of interactions between local applications.

In Step 204, a second characteristic value for the preset service characteristics corresponding to the processing result of the target service is determined. In one embodiment, step 204 may be implements as follows.

At least one output parameter objective that is called to process the service is determined, then the second characteristic value for the preset service characteristics corresponding to the processing result of the target service is determined based on the attribute information of the at least one output parameter objective.

Using the package service as an example, at least one interface that is called to process the package service is determined, then the output parameter of any of the at least one interface is intercepted to obtain the output parameter objective of the interface.

Then, the attributes of at least one output parameter objective is traversed to find the attributes (such as attribute of cell-phone number) corresponding to the preset service characteristics, the second characteristic value for the preset service characteristics is determined based on the attribute information of the attribute, that is, the second cell-phone number.

The at least one output parameter objective comprises at least one of a first output parameter objective of a remote service interface and a second output parameter objective of a local service interface, and the second output parameter objective comprises at least one of an output parameter objective of data and an output parameter objective of messages. The objective or destination of data is the processing result for the service data related to the package service, and the objective or destination of messages is the result of interactions between local applications.

In Step 206, the output of the processing result is prohibited if the first characteristic value and the second characteristic value do not match.

Using the package service as an example, the first and second cell-phone numbers should be the same, that is, the first and second characteristic values should match. Therefore, if the first and second cell-phone numbers are different, it is considered that an abnormal situation occurs in the process of processing the package service. The output of package processing results is intercepted, and a prompt message is issued to the relevant service processing personnel.

In this embodiment, the characteristic value for the preset service characteristics is determined before the service processing, and the characteristic value is determined again after the service processing. Then, if the characteristic value before the capital service processing and the characteristic value after the capital service processing are inconsistent, the output of the processing result of the service is intercepted. Compared with the prior art, it can effectively monitor the abnormal situation of service processing and thus avoid the loss caused by abnormal service processing.

In addition, the method is described as a series of combinations of actions for a simplified description, but those skilled in the art should be aware that the specification is not limited by the described sequence of actions. Certain steps may be performed in other sequences or simultaneously in accordance with the embodiments of the specification. Further, those skilled in the art should also be aware that the embodiments in the specification are some of the embodiments, and some of the actions comprised in the embodiments may not be necessary in the specification.

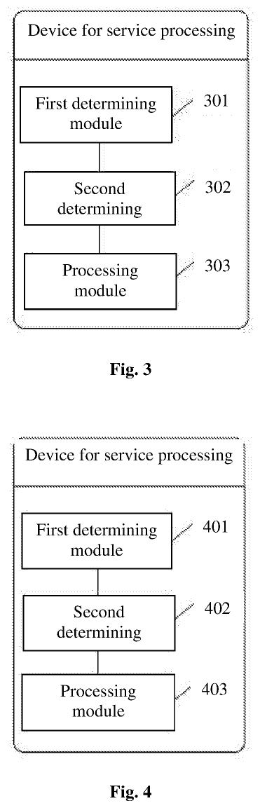

FIG. 3 is a structure diagram for a device for service processing provided in one embodiment of the specification. Referring to FIG. 3, the device comprises a first determining module 301, a second determining module 302, and a processing module 303.

The first determining module 301 is used for determining the first currency information of the capital service to be processed.

The second determining module 302 is used for determining the second currency information corresponding to the processing result of the capital service.

The processing module 303 is used for prohibiting the output of the processing result if the first currency information and the second currency information do not match.

In an amendment, the first determining module 301 is used for determining at least one input parameter objective that is called to process the capital service, and determining the first currency information for the capital service based on the attribute information of the at least one input parameter objective.

In an amendment, the first determining module 301 is used for determining at least one interface that is called to process the capital service, and when detecting that any of the at least one interface is called, reading the input parameter of the interface to obtain the input parameter objective of the interface.

In an amendment, the first determining module 301 is used for traversing the attributes of at least one input parameter objective to find the preset currency attributes, and determining the first currency information of the capital service based on the attribute information of the currency attribute.

In an amendment, the at least one input parameter objective comprises at least one of a first input parameter objective of a remote service interface and a second input parameter objective of a local service interface, and the second input parameter objective comprises at least one of an input parameter objective of data and an input parameter objective of messages.

The objective or destination of data is the service data related to the capital service, and the objective or destination of messages is the messages of interactions between local applications.

In an amendment, the second determining module 302 is used for determining at least one output parameter objective that is called to process the capital service, and determining the second currency information for the processing result of the capital service based on the attribute information of the at least one output parameter objective.

In an amendment, the second determining module 302 is used for determining at least one interface that is called to process the capital service, and intercepting the output parameter of any of the at least one interface to obtain the output parameter objective of the interface.

In an amendment, the second determining module 302 is used for traversing the attributes of at least one output parameter objective to find the preset currency attributes, and determining the second currency information of the capital service based on the attribute information of the currency attribute.

In an amendment, the at least one output parameter objective comprises at least one of a first output parameter objective of a remote service interface and a second output parameter objective of a local service interface, and the second output parameter objective comprises at least one of an output parameter objective of data and an output parameter objective of messages.

The objective of data is the service processing results related to the capital service, and the objective of messages is the result of interactions between local applications.

In an amendment, the device also comprises a currency verification module used for determining whether the first currency information and the second currency information are the same. If they are the same, the first currency information and the second currency information are determined to be matched. If they are not the same, the first currency information and the second currency information are determined not to be matched.

The first currency information is determined based on the target input parameter objective, while the second currency information is determined based on the target output parameter objective, and the target input parameter objective and the target output parameter objective are a pair of input parameter objective and output parameter objective for any interface that is called to process the capital service.

In an amendment, the processing module 303 is also used for allowing the output of the processing result if the first currency information and the second currency information match.

In an amendment, the processing module 303 is also used for issuing alarm information if the first currency information and the second currency information do not match.

In this embodiment, the currency information is determined before the capital service processing, and the currency information is determined again after the capital service processing. If the currency information before the capital service processing and the currency information after the capital service processing are inconsistent, the output of the processing result of the capital service is intercepted. Compared with the prior art, it can effectively monitor whether the currency is tampered or not, thus avoiding the capital loss caused by tampering of currency.

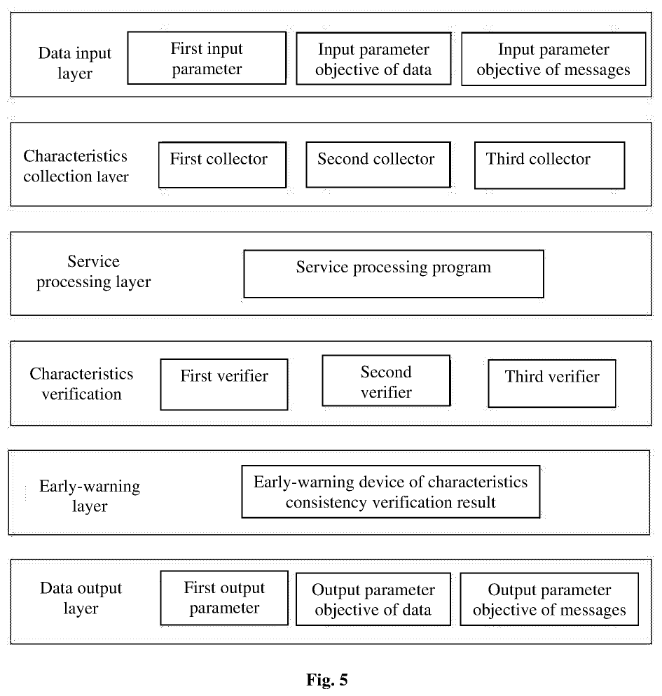

FIG. 4 is a structure diagram for a device for service processing provided in another embodiment of the specification. Referring to FIG. 4, the device comprises the first determining module 401, the second determining module 402, and the processing module 403.

The first determining module 401 is used for determining the first characteristic value for the preset service characteristics of the target service to be processed.

The second determining module 402 is used for determining the second characteristic value for the preset service characteristics corresponding to the processing result of the target service.

The processing module 403 is used for prohibiting the output of the processing result if the first characteristic value and the second characteristic value do not match.

In an amendment, the first determining module 401 is used for determining at least one input parameter objective that is called to process the target service, and determining the first characteristic value for the preset service characteristics based on the attribute information of the at least one input parameter objective.

In an amendment, the first determining module 401 is used for: determining at least one interface that is called to process the target service; and when any of the at least one interface is detected to be called, reading the input parameter of the interface to obtain the input parameter objective of the interface.

In an amendment, the first determining module 401 is used for traversing the attributes of at least one input parameter objective to find the attributes corresponding to the preset service characteristics, and determining the first characteristic value for the preset service characteristics based on the attribute information of the attribute.

In an amendment, the at least one input parameter objective comprises at least one of a first input parameter objective of a remote service interface and a second input parameter objective of a local service interface, and the second input parameter objective comprises at least one of an input parameter objective of data and an input parameter objective of messages.

The objective or destination of data includes the service data related to the target service, and the objective or destination of messages includes the messages of interactions between local applications.

In an amendment, the second determining module 402 is used for determining at least one output parameter objective that is called to process the service, and determining the second characteristic value for the preset service characteristics corresponding to the processing result of the target service based on the attribute information of the at least one output parameter objective.

In an amendment, the second determining module 402 is used for determining at least one interface that is called to process the target service, and intercepting the output parameter of any of the at least one interface to obtain the output parameter objective of the interface.

In an amendment, the second determining module 402 is used for traversing the attributes of at least one output parameter objective to find the attributes corresponding to the preset service characteristics, and determining the second characteristic value for the preset service characteristics based on the attribute information of the attribute.

In an amendment, the at least one output parameter objective comprises at least one of a first output parameter objective of a remote service interface and a second output parameter objective of a local service interface, and the second output parameter objective comprises at least one of an output parameter objective of data and an output parameter objective of messages.

The objective of data includes the service processing results related to the target service, and the objective of messages includes the result of interactions between local applications.

In an amendment, the device also comprises a characteristic value verification module used for determining whether the first characteristic value and the second characteristic value are the same. If they are the same, the first characteristic value and the second characteristic value are determined to be matched. If they are not the same, the first characteristic value and the second characteristic value are determined to be not matched.

The first characteristic value is determined based on the target input parameter objective, while the second characteristic value is determined based on the target output parameter objective, and the target input parameter objective and the target output parameter objective are a pair of input parameter objective and output parameter objective for any interface that is called to process the target service.

In an amendment, the processing module 403 is also used for allowing the output of the processing result if the first characteristic value and the second characteristic value match.

In an amendment, the processing module 403 is also used for issuing alarm information if the first characteristic value and the second characteristic value do not match.

In this embodiment, the characteristic value for the preset service characteristics is determined before the service processing, and the characteristic value is determined again after the service processing. Then, if the characteristic value before the capital service processing and the characteristic value after the capital service processing are inconsistent, the output of the processing result of the service is intercepted. Compared with the prior art, it can effectively monitor the abnormal situation of service processing and thus avoid the loss caused by abnormal service processing.

In addition, since the functions of the above device are similar to the functions of the method, for relevant points, please refer to the detailed description of the method. Furthermore, among the components of the device of the specification, the components are logically divided according to the to be realized functions thereof. However, the components can also be re-divided or combined as required.

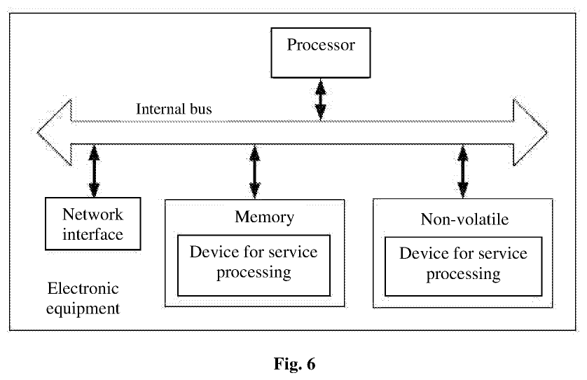

FIG. 5 is a structure diagram for a system for service processing provided in one embodiment of the specification. Referring to FIG. 5, the system comprises a data collection layer, a characteristics collection layer, a service processing layer, a characteristics verification layer, an early warning layer, and a data output layer.

The rules of the capital service usually require the consistency of currency information throughout the system processing. Using a loan repayment of CNY as an example, the currency should be kept consistent, i.e., CNY, in the process of the capital repayment. Therefore, the capital service is used as an example to describe details of each layer.

The data collection layer is usually used for collecting three types of data which comprises the input parameter objective calling the service interface of remote computers (the first input parameter objective), the storage-level data (input parameter objective of data), and the received messages (input parameter objective of messages).

In some embodiments, every type of data may comprise the currency information of the capital.

The characteristics collection layer is used for establishing different currency collectors, and for providing initialized currency information for the subsequent currency consistency check. The currency collectors include a first collector corresponding to the first input parameter objective, a second collector corresponding to input parameter objective of data, and a third collector corresponding to input parameter objective of messages.

The first collector is used for reading and analyzing the first input parameter objective from the data collection layer, to obtain the first currency information. The second collector is used for reading and analyzing the input parameter objective of data from the data collection layer, to obtain the second currency information. The third collector is used for reading and analyzing the input parameter objective of messages from the data collection layer, to obtain the third currency information.

The first input parameter objective and the input parameter objective of messages may include complex types of capital parameters, the first and second collectors need to adapt to specific parameter types to analyze and store the currency information. The second collector can adapt automatically according to the type of database used for system storage and different storage devices, and the system begins to intercept and collect the currency information when reading the data in the storage layer.

The service processing layer is used for running the service processing program to process the capital service when the external call or message is received.

The characteristics verification layer is used for collecting the output parameter objective generated after the execution of the service processing program is completed, and comprises the first output parameter objective, and the output parameter objective of data and the output parameter objective of messages. Then the three output parameter objectives are analyzed to obtain the currency information of each output parameter objective, the currency information corresponding to each output parameter objective is compared with the currency information for the input parameter objective corresponding to the output parameter objective, and the comparing result is transmitted to the early-warning layer.

The consistency comparison rules can include comparison between the currency information corresponding to the first input parameter objective and the currency information corresponding to the first output parameter objective, comparison between the currency information corresponding to the input parameter objective of data and the currency information corresponding to the output parameter objective of data, and comparison between the currency information corresponding to the input parameter objective of messages and the currency information corresponding to the output parameter objective of messages.

A second verifier is used for intercepting and analyzing the currency information before the output parameter objective of data is written into the physical disk. A third verifier is used for intercepting and analyzing the currency information before the output parameter objective of messages is sent.

The early-warning layer is used for initiating an early-warning device of characteristics consistency verification result after receiving the verification result from the characteristics verifier, so as to intercept the system from subsequence execution and avoid generating error data when the inconsistency is detected, meanwhile issuing alarm information to notify system developing and maintenance personnel to process this situation.

The data output layer is used for normal output of all generated data, if the early-warning device does not issue any alarm information indicating the success of the currency consistency check.

In this embodiment, the characteristic value for the preset service characteristics is determined before the service processing, and the characteristic value is determined again after the service processing. If the characteristic value before the capital service processing and the characteristic value after the capital service processing are inconsistent, the output of the processing result of the service is intercepted. Compared with the prior art, it can effectively monitor the abnormal situation of service processing and thus avoid the loss caused by abnormal service processing.

FIG. 6 is a structure diagram for electronic equipment provided in one embodiment of the specification. Referring to FIG. 6, the electronic equipment comprises a processor, an internal bus, a network interface, a memory, a non-volatile memory, and, may comprise hardware needed for other services. The processor reads the corresponding computer program from the non-volatile memory into the memory and then runs it, forming a service processing unit at the logical level. In addition to a form of software, the specification may be implemented in other forms, such as a logic device combining hardware and software. The executive entity of the following process is not limited to individual logic units, and can be hardware or logic devices.

The network interface, processor and memory can be interconnected via the bus. The bus can be an Industry Standard Architecture (ISA) bus, a Peripheral Component Interconnect (PCI) bus or an Extended Industry Standard Architecture (EISA) bus and the like. The bus can be divided into address bus, data bus, control bus and so on. For ease of illustration, only a double-sided arrow is used in FIG. 6, but it does not mean that there is only one bus or one type of bus.

The memory is used to store programs. Specifically, the program may include program codes that include computer operating instructions. The memory can include a read-only memory and a random access memory and provide instructions and data to the processor. The memory may contain a high-speed Random-Access Memory (RAM), or it may also include a non-volatile memory, such as at least one disk memory.

The processor is used for executing the program stored on the memory and performing operations including determining first currency information of the capital service to be processed; determining second currency information corresponding to the processing result of the capital service, and prohibiting the output of the processing result if the first currency information and the second currency information do not match.

In an embodiment, operations includes determining a first characteristic value for the preset service characteristics of the target service to be processed, determining a second characteristic value for the preset service characteristics corresponding to the processing result of the target service, and prohibiting the output of the processing result if the first characteristic value and the second characteristic value do not match.

The device for service processing disclosed by the embodiments shown in FIGS. 3-4 of the specification or the method executed by the Master node can be applied in the processor or can be realized by the processor. The processor can be a kind of integrated circuit chip, with a signal processing capability. In the implementation process, each step of the above method can be completed through the integrated logic circuit of the hardware in the processor or the instructions in the form of software. The processor can be a general processor, comprising a Central Processing Unit (CPU), a Network Processor (NP) and the like; and can also be a Digital Signal Processor (DSP), an Application Specific Integrated Circuit (ASIC), a Field-Programmable Gate Array (FPGA) or other programmable logic devices, discrete gates, transistor logic devices, discrete hardware components. The methods, steps and logic block diagrams disclosed in the specification can be implemented or executed. A general-purpose processor can be a microprocessor, or it can be any conventional processor, etc. The steps in combination with the method disclosed in the embodiments of the specification may be directly embodied in the completion of the execution by the hardware decoding processor or by a combination of hardware and software modules in the decoding processor. Software modules can be in a random-access memory, a flash memory, a read-only memory, a programmable read-only memory or an electrically erasable programmable memory, a register and other mature storage media in the field. The storage media is in the memory, the processor reads the information in the memory and completes the steps of the above method in combination with its hardware.

The device for service processing can also execute the method as shown in FIGS. 1-2 and implement the method executed by the Master node.

The embodiments of the specification also provide a computer readable storage media that stores one or more programs, and the one or more programs, when executed by the electronic equipment including multiple applications, enable the electronic equipment to execute the method for service processing provided in the embodiments as shown in FIGS. 1-2.

Each embodiment in the specification is described in a progressive manner, and the same and similar parts among the embodiment shall be referred mutually. Each embodiment highlights the differences with other embodiments. The embodiments of the system are similar to the embodiments of the method, so the former is described in a relatively simple way. For relevant points, please refer to the description for the embodiments of the method.

Specific embodiments of the specification are described above. Other embodiments are within the extent of the attached claims. In some cases, the actions or steps recorded in the claims may be performed in a different order than in the embodiments and still achieve the desired results. In addition, the process depicted in the drawings does not necessarily require a specific order or a sequential order to achieve the desired results. In some embodiments, multitasking and parallel processing are also possible or may be beneficial.

Those skilled in the art shall understand that embodiments of the specification may be provided as methods, systems or computer program products. Thus, the specification may use the form of a complete hardware embodiment, a complete software embodiment or a combination of hardware and software embodiments. Furthermore, the specification uses the form of computer program products implemented on one or more computer-usable storage media (including but not limited to disk memory, CD-ROM, optical memory, etc.) containing computer-usable program codes.

The embodiments are described with reference to a flow chart and/or block diagram of a method, a device (system), and a computer program product. It shall be understood that each flow and/or block in the flow charts and/or block diagrams and the combination of flows and/or blocks in the flow charts and/or block diagrams can be implemented by instructions of computer program. The instructions of computer program can be provided for the processors of general-purpose computers, special computers, embedded processors or other programmable data processing equipment to form a machine, so as to produce devices for realizing the functions specified in one or more flows of the flow charts and/or in one or more blocks of the block diagrams, by use of the instructions executed by the processors of computers or other programmable data processing equipment.

These instructions of computer program can also be stored in the computer readable memories capable of guiding computers or other programmable data processing equipment to work in a certain way, so the instructions stored in the computer readable memories to produce manufactures including instructing devices, which can realize the functions specified in one or more flows of the flow charts and/or in one or more blocks of the block diagrams.

These instructions of computer program can also be loaded onto computers or other programmable data processing equipment, to execute a series of steps on the computers or other programmable data processing equipment to complete the processing realized by computers, so that the instructions executed on the computers or other programmable data processing equipment provide the steps of realizing the functions specified in one or more flows of the flow charts and/or in one or more blocks of the block diagrams.

In a typical configuration, the computing device comprises one or more processors (CPU), input/output interfaces, network interfaces and memories.

The memory may include such forms as non-permanent memory in computer readable media, random access memory (RAM), and/or non-volatile memory, such as read-only memory (ROM) or flash memory (flash RAM). The memory is an example of a computer readable media.

The computer readable media include permanent and non-permanent, removable and non-removable media, and any method or technology can be used to achieve information storage. Information can be computer readable instructions, data structures, program modules, or other data. Examples of computer storage media includes but not limited to: phase change memories (PRAM), static random access memories (SRAM) and dynamic random access memories (DRAM), other types of random access memories (RAM), read-only memories (ROM), electrically erasable programmable read-only memories (EEPROM), flash memory or other memory technologies, read-only memories (CD-ROM), digital versatile disc (DVD) or other optical storages, cassette tapes, magnetic tapes, magnetic disks, disk storages or other

The computer readable media include permanent and non-permanent, removable and non-removable media, and any method or technology can be used to achieve information storage. Information can be computer readable instructions, data structures, program modules, or other data. Examples of computer storage media includes but not limited to: phase change memories (PRAM), static random access memories (SRAM) and dynamic random access memories (DRAM), other types of random access memories (RAM), read-only memories (ROM), electrically erasable programmable read-only memories (EEPROM), flash memory or other memory technologies, read-only memories (CD-ROM), digital versatile disc (DVD) or other optical storages, cassette tapes, magnetic tapes, magnetic disks, disk storages or other magnetic storage devices or any other non-transmission media, which can store information accessible by computing devices. As defined herein, computer readable media does not include transitory media, such as modulated data signals and carriers.

Further, it should be noted that: the terms “comprise(s)”, “include(s)” or any other variant is intended to cover non-exclusive inclusion, so that the process, method, commodity or equipment including a series of elements does not comprise these elements, but also others that are not clearly listed, or also comprises the inherent elements of the process, method, commodity or equipment. In the absence of more restrictions, the elements defined by the statement “comprise(s)/comprising a . . . ” shall not exclude that other same elements also exist in the process, method, commodity or equipment including the elements.

Person having ordinary skill in the field shall understand that embodiments of the specification may be provided as methods, systems or computer program products. Thus, the specification may use the form of a complete hardware embodiment, a complete software embodiment or a combination of hardware and software embodiments. Furthermore, the specification uses the form of computer program products implemented on one or more computer-usable storage media (including but not limited to disk memory, CD-ROM, optical memory, etc.) containing computer-usable program codes.

The foregoing are only embodiments of the specification and are not intended to limit the specification. For those skilled in the art, the specification is subject to a variety of modifications and variations. Any amendment, equivalent substitution, improvement and the like made within the spirits and principles of the specification shall be included in the claims of the specification.

What is claimed is:

1. A method for service processing, comprising:
determining, by a server, a first characteristic value of preset service characteristics of a target service to be processed, wherein the first characteristic value is determined based on attribute information of at least one input parameter objective of an interface that is called to process the target service;
processing, by the server, the target service to obtain a processing result;
determining, by the server, a second characteristic value of the preset service characteristics corresponding to the processing result of the target service, wherein the second characteristic value is determined based on attribute information of at least one output parameter objective of an interface that is called to process the target service; and
in response to determining that the first characteristic value and the second characteristic value do not match, prohibiting, by the server, output of the processing result.

2. The method according to claim 1, wherein the at least one input parameter objective of an interface that is called to process the target service is determined by:
determining at least one interface that is called to process the target service; and
reading input parameters of the interface when detecting that one of the at least one interface is called, to obtain the input parameter objective of the interface.

3. The method according to claim 2,
wherein the at least one input parameter objective comprises at least one of a first input parameter objective of a remote service interface and a second input parameter objective of a local service interface, and the second input parameter objective comprises at least one of an input parameter objective of data and an input parameter objective of messages; and
wherein objective of the data includes service data related to the target service, and objective of the messages include an interaction message between local applications.

4. The method according to claim 1, wherein the at least one input parameter objective of an interface that is called to process the target service is determined by:
determining at least one interface that is called to process the target service; and
reading output parameters of the interface when detecting that one of the at least one interface is called, to obtain the output parameter objective of the interface.

5. The method according to claim 4,
wherein the at least one output parameter objective comprises at least one of a first output parameter objective of a remote service interface and a second output parameter objective of a local service interface, and the second output parameter objective comprises at least one of an output parameter objective of data and an output parameter objective of messages; and
wherein objective of the data includes the processing result of the target service, and objective of the messages include an interaction result between local applications.

6. The method according to claim 1, further comprising:
determining whether the first characteristic value and the second characteristic value are the same; and
in response to determining that the first characteristic value and the second characteristic value are the same, determining that the first characteristic value and the second characteristic value match, and in response to determining that the first characteristic value and the second characteristic value are not the same, determining that the first characteristic value and the second characteristic value do not match;
wherein, the first characteristic value is determined based on a target input parameter of a first interface called to process the target service objective, and the second characteristic value is determined based on a target output parameter of a second interface called to process the target service.

7. The method according to claim 6, further comprising:
allowing the output of the processing result if the first characteristic value and the second characteristic value match; and
generating alarm information if the first characteristic value and the second characteristic value do not match.

8. Electronic equipment for service processing, comprising:
a processor and a non-transitory computer-readable storage medium storing instructions executable by the processor to cause the system to perform operations comprising:
determining a first characteristic value of preset service characteristics of a target service to be processed, wherein the first characteristic value is determined based on attribute information of at least one input parameter objective of an interface that is called to process the target service;
processing the target service to obtain a processing result;
determining a second characteristic value of the preset service characteristics corresponding to the processing result of the target service, wherein the second characteristic value is determined based on attribute information of at least one output parameter objective of an interface that is called to process the target service; and
in response to determining that the first characteristic value and the second characteristic value do not match, prohibiting output of the processing result.

9. The electronic equipment according to claim 8, wherein the at least one input parameter objective of an interface that is called to process the target service is determined by:
determining at least one interface that is called to process the target service; and
reading input parameters of the interface when detecting that one of the at least one interface is called, to obtain the input parameter objective of the interface.

10. The electronic equipment according to claim 9,
wherein the at least one input parameter comprises at least one of a first input parameter of a remote service interface and a second input parameter of a local service interface, and the second input parameter comprises at least one of an input parameter of data and an input parameter of messages; and
wherein the data includes service data related to the target service, and the messages include an interaction message between local applications.

11. The electronic equipment according to claim 8, wherein the at least one input parameter objective of an interface that is called to process the target service is determined by:
determining at least one interface that is called to process the target service; and
reading output parameters of the interface when detecting that one of the at least one interface is called, to obtain the output parameter objective of the interface.

12. The electronic equipment according to claim 11,
wherein the at least one output parameter comprises at least one of a first output parameter of a remote service interface and a second output parameter of a local service interface, and the second output parameter comprises at least one of an output parameter of data and an output parameter of messages; and
wherein objective of the data includes the processing result of the target service, and objective of the messages include an interaction result between local applications.

13. The electronic equipment according to claim 8, wherein the operations further comprise:
determining whether the first characteristic value and the second characteristic value are the same; and
in response to determining that the first characteristic value and the second characteristic value are the same, determining that the first characteristic value and the second characteristic value match, and in response to determining that the first characteristic value and the second characteristic value are not the same, determining that the first characteristic value and the second characteristic value do not match;
wherein, the first characteristic value is determined based on a target input parameter of a first interface called to process the target service, and the second characteristic value is determined based on a target output parameter of a second interface called to process the target service.

14. The electronic equipment according to claim 13, wherein the operations further comprise:
allowing the output of the processing result if the first characteristic value and the second characteristic value match; and
generating alarm information if the first characteristic value and the second characteristic value do not match.

15. A non-transitory computer-readable storage medium for service processing, configured with instructions executable by one or more processors to cause the one or more processors to perform operations comprising:
determining a first characteristic value of preset service characteristics of a target service to be processed, wherein the first characteristic value is determined based on attribute information of at least one input parameter objective of an interface that is called to process the target service;
processing the target service to obtain a processing result;
determining a second characteristic value of the preset service characteristics corresponding to the processing result of the target service, wherein the second characteristic value is determined based on attribute information of at least one output parameter objective of an interface that is called to process the target service; and
in response to determining that the first characteristic value and the second characteristic value do not match, prohibiting output of the processing result.

16. The storage medium according to claim 15, wherein the at least one input parameter objective of an interface that is called to process the target service is determined by:
determining at least one interface that is called to process the target service; and
reading input parameters of the interface when detecting that one of the at least one interface is called, to obtain the input parameter objective of the interface.

17. The storage medium according to claim 16,
wherein the at least one input parameter comprises at least one of a first input parameter of a remote service interface and a second input parameter of a local service interface, and the second input parameter comprises at least one of an input parameter of data and an input parameter of messages; and
wherein the data includes service data related to the target service, and the messages include an interaction message between local applications.

18. The storage medium according to claim 15, wherein the at least one input parameter objective of an interface that is called to process the target service is determined by:
determining at least one interface that is called to process the target service; and
reading output parameters of the interface when detecting that one of the at least one interface is called, to obtain the output parameter objective of the interface.

19. The storage medium according to claim 18,
wherein the at least one output parameter comprises at least one of a first output parameter of a remote service interface and a second output parameter of a local service interface, and the second output parameter comprises at least one of an output parameter of data and an output parameter of messages; and
wherein objective of the data includes the processing result of the target service, and objective of the messages include an interaction result between local applications.

20. The storage medium according to claim 15, wherein the operations further comprise:
determining whether the first characteristic value and the second characteristic value are the same; and
in response to determining that the first characteristic value and the second characteristic value are the same, determining that the first characteristic value and the second characteristic value match, and in response to determining that the first characteristic value and the second characteristic value are not the same, determining that the first characteristic value and the second characteristic value do not match;
wherein, the first characteristic value is determined based on a target input parameter of a first interface called to process the target service, and the second characteristic value is determined based on a target output parameter of a second interface called to process the target service.
